(19) United States
(12) Patent Application Publication
(10) Pub. No.: US 2021/0047210 A1
(43) Pub. Date: Feb. 18, 2021

(54) FLOW APPARATUS FOR TREATING PHARMACEUTICAL WASTE

(71) Applicant: Clear River Enviro, Inc., Sugar Land, TX (US)

(72) Inventor: Mark Minter Macdonell, Sugar Land, TX (US)

(73) Assignee: Clear River Enviro, Inc., Sugar Land, TX (US)

(21) Appl. No.: 16/986,423

(22) Filed: Aug. 6, 2020

Related U.S. Application Data
(60) Provisional application No. 62/886,142, filed on Aug. 13, 2019.

(51) Int. Cl. C02F 1/72; G05D 7/06; C02F 1/00

(52) U.S. Cl. CPC C02F 1/722; G05D 7/0688; C02F 2103/343; C02F 1/008; C02F 1/725

(57) ABSTRACT

A system for treating pharmaceutical waste at a location at which the pharmaceutical waste is disposed includes a waste conduit having an inlet that is configured to receive the pharmaceutical waste, a diluent conduit fluidly coupled to the waste conduit and configured to discharge water into the waste conduit, a first reagent conduit fluidly coupled to the waste conduit and configured to dispense a first reagent into the waste conduit, and a second reagent conduit fluidly coupled to the waste conduit and configured to discharge a second reagent into the waste conduit. In some embodiments, the waste conduit further comprises an outlet disposed downstream from the second reagent conduit. The waste conduit may be free of waste-receiving vessels between the inlet and the outlet.

### CROSS-REFERENCE TO RELATED PATENT APPLICATIONS

The present application claims the benefit of and priority to U.S. Provisional Patent Application No. 62/886,142, filed Aug. 13, 2019, the entire disclosure of which is hereby incorporated by reference herein.

### FIELD

The present disclosure is generally related to degrading and eliminating concentrations of drugs from water. More specifically, the disclosure relates to a compact drainage system and method for treating, at a location of disposal, pharmaceutical waste contained in waste water.

### BACKGROUND

Waste water contamination is an important issue, especially in hospital, dental, home care and other settings where pharmaceutical waste is commonly discarded. Healthcare workers or patients often dispose of pharmaceutical waste incorrectly, often unintentionally, which can lead to contaminated waste water. For example, items that contain toxic chemicals are routinely poured down sinks or flushed down toilets. Since most waste water treatment facilities do not specifically treat for these chemicals, this can lead to problems of pollution if pharmaceutical waste makes its way into public water supplies.

The EPA has identified 1,500 publicly owned treatment works (“POTWs”) that are required to have a pretreatment program, and another 13,500 facilities that are not required to have a pretreatment program. Given the breadth of potential contaminants, the EPA focuses on the following waste materials: mercury, primarily from dental facilities, but also from some medical equipment devices; and unused pharmaceuticals. Unused pharmaceuticals include animal and human drugs such as wasted pills, excess liquid formulations (injectables and swallowed) and spilled biohazards. Current best management practices include incineration or disposal of the pharmaceutical waste in a solid-waste landfill. However, most pharmaceutical waste is still disposed by being poured down a sink.

Common pharmaceuticals that are considered “hazardous wastes” under the Resource Conservation and Recovery Act (“RCRA”) include epinephrine, nitroglycerin, warfarin, nicotine, and many chemotherapy agents. These pharmaceutical waste items are subject to unique and expensive disposal requirements, since the EPA regulates the generation, storage, transportation, treatment, and disposal of any pharmaceutical waste defined as hazardous waste by RCRA.

### SUMMARY

One embodiment relates to a system for treating pharmaceutical waste at a location at which the pharmaceutical waste is disposed. The system includes a waste conduit having an inlet that is configured to receive the pharmaceutical waste, a diluent conduit fluidly coupled to the waste conduit and configured to discharge water into the waste conduit, a first reagent conduit fluidly coupled to the waste conduit and configured to dispense a first reagent into the waste conduit, and a second reagent conduit fluidly coupled to the waste conduit and configured to discharge a second reagent into the waste conduit. In some embodiments, the waste conduit further comprises an outlet disposed downstream from the second reagent conduit. The waste conduit may be free of waste-receiving vessels between the inlet and the outlet. In some embodiments, the system is configured such that pharmaceutical waste flows continuously along an entire length of the waste conduit.

Another embodiment relates to a control system. The control system includes an inlet flow sensor coupled to a waste conduit, a diluent dispensing system fluidly coupled to the waste conduit downstream of the inlet flow sensor, a reagent dispensing system fluidly coupled to the waste conduit downstream of the diluent dispensing systems, and a pharmaceutical waste disposal circuit communicably coupled to the inlet flow sensor, the diluent dispensing system, and the reagent dispensing systems. The pharmaceutical waste disposal circuit configured to receive inlet data indicative of an inlet fluid flow rate from the inlet flow sensor, determine a diluent flow rate based on the inlet fluid flow rate, selectively operate the diluent dispensing device to dispense diluent based on the diluent flow rate, determine a reagent flow rate based on the inlet fluid flow rate and the diluent flow rate, and selectively operate the reagent dispensing device to dispense reagent based on the reagent flow rate. In some embodiments, the control system further includes a fluid driver communicably coupled to the pharmaceutical waste disposal circuit. The fluid driver may be configured to move fluid continuously along an entire length of the waste conduit. The pharmaceutical waste disposal circuit may be further configured to selectively activate the fluid driver based on the inlet fluid flow rate. In some embodiments, the control system further includes an outlet flow sensor downstream of the reagent dispensing device and communicably coupled to the pharmaceutical waste disposal circuit. The pharmaceutical waste disposal circuit may be configured to control the fluid driver based on outlet data from the outlet flow sensor.

Yet another embodiment is a method of treating pharmaceutical waste at a location at which the pharmaceutical waste is disposed. The method includes receiving inlet data indicative of an inlet fluid flow rate into a waste conduit from an inlet flow sensor; determining a diluent flow rate based on the inlet fluid flow rate; dispensing, via a diluent dispensing system, a diluent into the waste conduit based on the diluent flow rate; determining a reagent flow rate based on the inlet fluid flow rate and the diluent flow rate; and dispensing, via a reagent dispensing system downstream from the diluent dispensing system, a reagent into the waste conduit based on the reagent flow rate. In some embodiments, the method further includes moving a pharmaceutical waste along the waste conduit continuously via a fluid driver that is fluidly coupled to the waste conduit.

### BRIEF DESCRIPTION OF THE DRAWINGS

The disclosure will become more fully understood from the following detailed description, taken in conjunction with the accompanying figures, in which:

FIG. 1 is a schematic drawing of a flow system for degrading and eliminating concentrations of drugs disposed by flushing and/or being poured down a sink, according to an embodiment; and

FIG. 2 is a flow diagram of a method of treating and disposing of pharmaceutical waste, according to an embodiment.

### DESCRIPTION

Technical and scientific terms used herein have the meanings commonly understood by one of ordinary skill in the art to which the present invention pertains, unless otherwise defined. Reference is made herein to various methodologies known to those of ordinary skill in the art. Any suitable materials and/or methods known to those of ordinary skill in the art can be utilized in carrying out the present invention. However, specific materials and methods are described. Materials, reagents and the like to which reference is made in the following description and examples are obtainable from commercial sources, unless otherwise noted.

Referring to the Figures generally, a drainage system is shown that is configured to receive and neutralize pharmaceutical waste at a location at which the pharmaceutical waste is disposed (i.e., at a sink if the pharmaceutical waste is poured down the sink), and by an individual that disposed of the pharmaceutical waste. The drainage system described herein allows the pharmaceutical waste to be treated on-site instead of off-site at a waste water treatment facility or publicly owned treatment works. The on-site treatment ensures that the appropriate procedures for degrading and eliminating the pharmaceutical waste are followed, and prevents pharmaceutical waste from being discharged into public water supplies.

Unlike existing systems that utilize separate holding and/or mixing tanks to treat pharmaceutical waste, the drainage system described herein is configured to neutralize pharmaceutical waste “on the fly” (e.g., without the use of holding tanks, vessels, and other waste-receiving vessels that are used to temporarily store the waste and/or to facilitate mixing of the reagents that are used to neutralize the pharmaceutical waste). The system includes a waste conduit (e.g., a waste receiving line, etc.) having an inlet and an outlet. The pharmaceutical waste is received at the inlet (e.g., an outlet of a sink, etc.) and passes continuously through the entirety of the waste conduit (e.g., unimpeded by flow valves, holding tanks, etc.), such that all mixing occurs substantially within the waste conduit. Stated another way, the system does not include any valves or other flow switching devices within the waste conduit to prevent the pharmaceutical waste from flowing between the inlet and the outlet at any point in time, or to direct the fluid to temporary holding or mixing tanks. The systems and methods described herein eliminate the need for moving parts to facilitate mixing between the pharmaceutical waste and other chemicals, thereby improving the overall reliability of the system. Additionally, because of the continuous flow configuration, the treatment time to fully neutralize the pharmaceutical waste may be less than conventional treatment methods.

The chemical reaction utilized by the drainage system to neutralize the pharmaceutical waste can be, for example, a chemical reaction that utilizes Fenton's reagent that occurs in the absence of ultraviolet (UV) light. One of ordinary skill in the art would appreciate that Fenton's reagent is a solution of hydrogen peroxide (e.g., H₂O₂) and an iron catalyst (e.g., FeSO₄, an aqueous iron solution) that is used to oxidize contaminants in waste waters. The hydrogen peroxide and the iron catalyst are provided directly to the waste conduit, for example, from a hydrogen peroxide cartridge and an aqueous iron cartridge, respectively. The chemical reaction may be similar to that described in detail in U.S. patent application Ser. No. 14/650,796, filed Dec. 18, 2013, the entire disclosure of which is hereby incorporated by reference herein.

In at least one embodiment, the system includes sensors that monitor the flow of fluid at different stages throughout the drainage system, and control the allocation of fluids for dilution and neutralization of the pharmaceutical waste. This ensures that the correct amount of each chemical is added during the treatment process. Additionally, the data provides diagnostic information that can be used to identify issues with the treatment process and to prevent the release of untreated or partially untreated pharmaceutical waste.

As used herein, the term “pharmaceutical waste” refers to drugs and/or medicines which may be in the form of solid pills and liquids. Although the systems and methods described herein are described with reference to pharmaceutical waste, it will be appreciated that similar techniques may be used to disposed of other contaminants and waste materials, such as mercury and other hazardous/toxic chemicals.

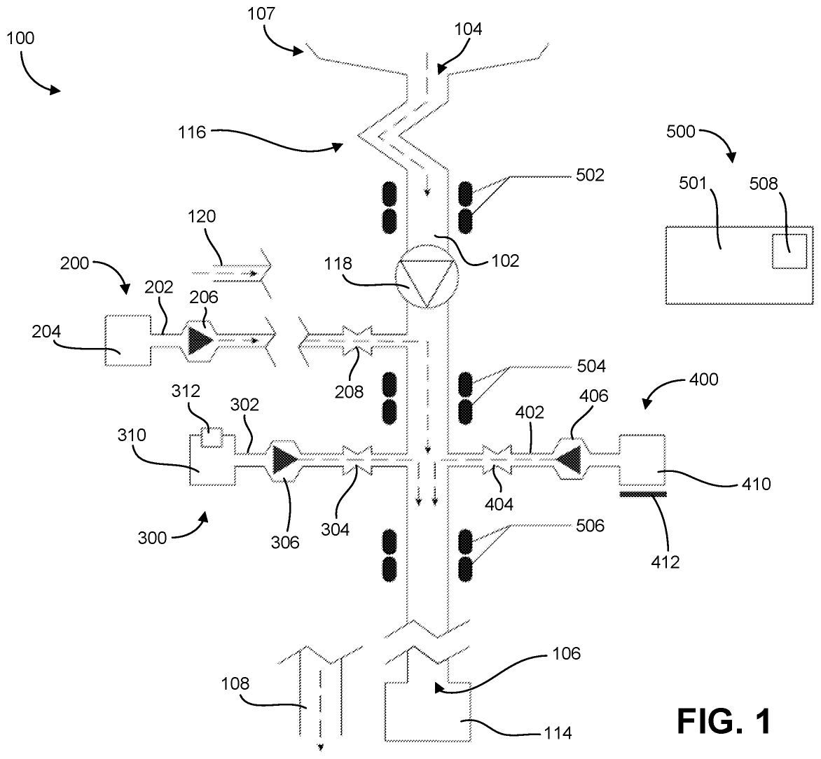

FIG. 1 shows a drainage system 100 configured to receive and neutralize pharmaceutical waste, according to an embodiment. The system 100 is configured to introduce various fluids to a single conduit to neutralize the pharmaceutical waste. As shown in FIG. 1, the system 100 includes a waste conduit 102 (e.g., waste receiving line, etc.) having an inlet 104 and an outlet 106. The pharmaceutical waste is received at the inlet 104, which may be fluidly connected to a sink, funnel, or other fluid directing vessel 107 and configured to receive water from the fluid directing vessel 107.

As shown in FIG. 1, the system 100 additionally include a diluent dispensing system 200, a first reagent dispensing system 300, and a second reagent dispensing system 400, each fluidly coupled to the waste conduit 102 between the inlet 104 and the outlet 106. The diluent dispensing system 200 is disposed upstream of both the first reagent dispensing system 300 and the second reagent dispensing system 400, along the waste conduit 102 between the inlet 104 and the first reagent dispensing system 300 and the second reagent dispensing system 400.

In the embodiment of FIG. 1, the outlet 106 of the waste conduit 102 is fluidly connected to an effluent tank 114, which receives treated pharmaceutical waste. The effluent tank 114 may be used in a mobile version of the drainage system 100 that can be transported between different locations. For example, the drainage system 100 may be disposed on a self-contained cart with casters to move the system 100 to different areas. The components of the drainage system 100 may be housed in a locked injection molded container or other form factor capable of being securely mounted onto the cart. In other embodiments, the system 100 is a permanent fixture (e.g., a permanently installed system) within a building that is mounted to a wall or countertop. When configured as a permanent fixture, the outlet 106 of the waste conduit 102 is fluidly connected to a building drain 108 leading to a municipal sewer system. In addition to the various fluid connections, the system 100 includes a control system, flow equipment, and sensors to monitor and control the treatment of pharmaceutical waste, as will be further described.

The fluid directing vessel 107 is configured to collect pharmaceutical waste and introduce the pharmaceutical waste into the waste conduit 102. The fluid directing vessel 107 may be made of a material that is impervious to chemical compounds present in the pharmaceutical waste. For example, the fluid directing vessel 107 can be made of stainless steel, polyurethane, polyethylene or any other suitable material. The fluid directing vessel 107 may be conical or substantially funnel-shaped to introduce fluid into the waste conduit 102 at a controlled rate, and to prevent the pharmaceutical waste from pooling within the fluid directing vessel 107.

As shown in FIG. 1, the waste conduit 102 is a fluid conduit, flow tube, channel, etc. that extends at least partially vertically away from a drain of the fluid directing vessel 107 so as to move the pharmaceutical waste away from the fluid directing vessel 107 by gravity. The system 100 (e.g., waste conduit 102) is free of holding tanks, mixing tanks, and other waste-receiving vessels along a flow path through the waste conduit 102, between the inlet 104 and the outlet 106. In other words, the system 100 does not contain any intermediate holding/mixing vessels for the pharmaceutical waste. The system 100 (e.g., waste conduit 102) is structured to process the pharmaceutical waste continuously as the waste moves along the waste conduit 102 rather than in discrete batches. As such, the system 100 (e.g., waste conduit 102) is configured to allow the pharmaceutical waste to pass freely (e.g., continuously, without interruption and without a substantial change in flow rate) therethrough at all times. Among other benefits, this structure allows the pharmaceutical waste to be treated on the fly while moving the waste toward the building drain or effluent tank 114.

The waste conduit 102 defines a “torture” or labyrinth path 116 at an upper end of the waste conduit 102, proximate to the drain of the fluid directing vessel 107, to preclude access to pharmaceutical waste received in the waste conduit 102. The labyrinth path 116 is a portion of the waste conduit 102 that zig-zags back and forth (e.g., left and right as shown in FIG. 1) forming a sideways “V” shape. In some embodiments, the system 100 (e.g., the fluid directing vessel 107 or the waste conduit 102) may also include a pre-filter or coarse screen (not illustrated) at an outlet of the fluid directing vessel 107 to prevent particulate contaminants (e.g., dirt, insoluble pharmaceutical waste, etc.) from entering the drainage system 100.

A first fluid driver 118 is coupled to the waste conduit 102 downstream from the fluid directing vessel 107. The first fluid driver 118 is configured to transport the contents of the fluid directing vessel 106 through the waste conduit 102 at a controlled rate (e.g., mL/minute, etc.). In the embodiment of FIG. 1, the first fluid driver 118 is a pump that is capable of varying the fluid flow rate through the waste conduit 102 in increments of, for example, 0.01 mL/minute. In other embodiments, the flow capacity and/or control resolution of the first fluid driver 118 may be different. In one embodiment, the first fluid driver 118 is communicably coupled to the control system, and is controlled by the control system based on sensor data, as will be further described. In another embodiment, the system 100 does not include a first fluid driver 118 and the flow rate of the pharmaceutical waste through the waste conduit 102 is limited by gravity.

The diluent dispensing system 200 is configured to supply diluent to the waste conduit 102 to dilute the pharmaceutical waste. The diluent may be water from a building water supply line (e.g., municipal water). As shown in FIG. 1, the diluent dispensing system 200 includes a diluent conduit 202 that is fluidly coupled to the waste conduit 102 downstream of the first fluid driver 118. In one embodiment, the diluent conduit 202 is a building water supply line 120 at normal building supply pressure (e.g., between approximately 40 psi and 60 psi, etc.). In another embodiment, as shown in FIG. 1, the diluent conduit 202 is a flow tube, channel, etc. that fluidly connects a water container 204 (e.g., vessel, tank, etc.) to the waste conduit 102. The diluent dispensing system 200 additionally includes a diluent pump 206 (e.g., a micropump or other fluid driver) and a diluent valve 208 (e.g., flow control valve) along the diluent conduit 202. The diluent valve 208 is disposed downstream from the diluent pump 206, between the diluent pump 206 and the waste conduit 102. The diluent pump 206 and the diluent valve 208 together are configured to selectively control an amount of diluent that is transferred from the water container 204 into the waste conduit 102 based on an amount of pharmaceutical waste that is flowing through the waste conduit 102. More specifically, the diluent pump 206 is configured to move the water through the diluent conduit 202 and the diluent valve 208 is configured to selectively fluidly couple the diluent pump 206 with the waste conduit 102. The diluent pump 206 and diluent valve 208 may be configured to vary the flow rate of diluent through the diluent conduit 202 in increments of, for example, 0.01 mL/min. In other embodiments, the flow capacity and/or control resolution of the diluent pump 206 may be different.

In some embodiments, the diluent dispensing system 200 may also be used to clean the drainage system 100 (e.g., waste conduit 102). For example, the diluent dispensing system 200 may be configured to continue dispensing water into the waste conduit 102 for a cleaning period after treatment of the pharmaceutical waste is complete to neutralize and remove any residual contaminants.

The water container 204 may include a fitting configured to connect to a water source such as the building water supply line 120. In another embodiment, the water container 204 may be manually refilled. As such, the water container 204 may include a sensor (e.g., a pressure sensor, liquid level sensor, etc.) configured to monitor an amount of water held therein. In one embodiment, the sensor is capable of outputting an alarm signal to the control system when the amount of water drops below a threshold value.

The first reagent dispensing system 300 and the second reagent dispensing system 400 are configured to dispense a first reagent and a second reagent, respectfully into the waste conduit 102, at approximately the same location along the waste conduit 102 in a flow direction, to neutralize the pharmaceutical waste. As shown in FIG. 1, the first reagent dispensing system 300 and the second reagent dispensing system 400 each include a fluid conduit, shown as first reagent conduit 302 and second reagent conduit 402. The first reagent conduit 302 is fluidly connected to the waste conduit 102 in parallel with the second reagent conduit 402, on opposing sides of the waste conduit 102. In other embodiments, the arrangement of the first reagent conduit 302 and the second reagent conduit 402 along the waste conduit 102 may be different. Each of the first reagent dispensing system 300 and the second reagent dispensing system 400 also include a valve (e.g., a flow control valve, shown as first reagent valve 304 and second reagent valve 404, respectively) and a pump (e.g., micropump or other fluid driver, shown as first reagent pump 306 and second reagent pump 406, respectively), which together are configured to selectively control the flow of reagent into the waste conduit 102. As shown in FIG. 1, each of the first reagent conduit 302 and the second reagent conduit 402 are fluidly connected to a replaceable fluid cartridge (e.g., reservoir, vessel, bag, etc.), which is configured to hold reagent for the chemical reaction used to neutralize the pharmaceutical waste.

In the embodiment of FIG. 1, the first reagent cartridge 310 is a hydrogen peroxide bag or another container that is configured to hold and dispense hydrogen peroxide (H₂O₂). The first reagent cartridge 310 may be hermetically sealed to prevent degradation of the hydrogen peroxide. In one embodiment, the hydrogen peroxide is 30% reagent grade hydrogen peroxide. A size of the first reagent cartridge 310 may be adjusted to suit the needs of individuals using the drainage system 100, for example, based on an average amount (e.g., volume) of pharmaceutical waste and the desired service interval of the drainage system 100. For example, the first reagent cartridge 310 may be capable of holding 500 mL of hydrogen peroxide or another suitable amount. In the embodiment of FIG. 1, the first reagent cartridge 310 includes a vent 312 made from polytetrafluoroethylene (PTFE) to prevent overpressure of the first reagent cartridge 310. The first reagent cartridge 310 may also include a pressure sensor, liquid level sensor, and/or weight sensor (e.g., scale) to monitor a quantity of first reagent. The sensor may be communicably coupled to the control system, and may be capable of outputting an alarm signal to the control signal when an amount of first reagent drops below a first reagent threshold.

The first reagent pump 306 is located downstream from the first reagent cartridge 310 and is configured to deliver the first reagent from the first reagent cartridge 310 to the waste conduit 102. The first reagent valve 304 is disposed along the first reagent conduit 302 downstream from the first reagent pump 306 (e.g., in between the first reagent pump 306 and the waste conduit 102). The first reagent pump 306 and the first reagent valve 308 together are configured to vary the flow rate of hydrogen peroxide through the first reagent conduit 302. More specifically, the first reagent pump 306 and the first reagent valve 308 are configured to move the first reagent through the first reagent conduit 302 based on an amount of pharmaceutical waste that is flowing through the waste conduit 102. The first reagent pump 306 and the first reagent valve 304 may be configured to vary the flow rate of first reagent through the first reagent conduit 302 in increments of, for example, 0.01 mL/min, or another suitable increment depending on the flow capacity of the drainage system 100.

The second reagent cartridge 410 is an aqueous iron bag (e.g., similar to that used for intravenous (IV) therapy, etc.) or another container that is configured to hold and dispense aqueous iron (iron (II) sulfate). The second reagent cartridge 410 may be hermetically sealed to reduce the formation of a precipitate. The aqueous iron may be, for example, ferrous sulfate heptahydrate. A size of the second reagent cartridge 410 may be adjusted to suit the needs of the individuals using the drainage system 100, for example, based on an average amount (e.g., volume) of pharmaceutical waste and the desired service interval of the drainage system 100. For example, the second reagent cartridge 410 may be capable of holding 250 mL to 1 L of aqueous iron, or another suitable amount. The second reagent cartridge 410 may also include a pressure sensor, liquid level sensor, and/or weight sensor to monitor a quantity of the second reagent. The sensor may be communicably coupled to the control system, and may be capable of outputting an alarm signal to the control signal when an amount of second reagent drops below a second reagent threshold.

The second reagent pump 406 is located downstream from the second reagent cartridge 410 and is configured to deliver the second reagent from the second reagent cartridge 410 to the waste conduit 102. The second reagent valve 408 is disposed along the second reagent conduit 402 downstream from the second reagent pump 406 (e.g., in between the second reagent pump 406 and the waste conduit 102). The second reagent pump 406 and the second reagent valve 408 together are configured to vary the flow rate of aqueous iron through the second reagent conduit 402. More specifically, the second reagent pump 406 and the second reagent valve 408 are configured to move the second reagent through the second reagent conduit 402 based on an amount of pharmaceutical waste that is flowing through the waste conduit 102. The second reagent pump 406 and the second reagent valve 408 may be configured to vary the flow rate of second reagent through the second reagent conduit 402 in increments of, for example, 0.01 mL/min, or another suitable increment depending on the flow capacity of the drainage system 100. In one embodiment, the flow rates of the first reagent pump 306 and the second reagent pump 406 are controlled by the control system such that an approximately 1:3 ratio of hydrogen peroxide to aqueous iron is transported into the waste conduit 102 during treatment operations.

As shown in FIG. 1, the drainage system 100 also includes a cooling plate 412 configured to regulate the temperature of the second reagent cartridge 410 (e.g., the aqueous iron). In one embodiment, the cooling plate 412 is a Peltier cooling plate that is disposed beneath the second reagent cartridge 410 and is engaged with a lower surface of the second reagent cartridge 410. In another embodiment, the cooling plate 412 may be disposed on another surface of the second reagent cartridge 410. In yet another embodiment, the cooling plate 412 may be replaced with a cooling jacket or another heat transfer device.

In the embodiment of FIG. 1, the diluent, first reagent, and second reagent mix with the pharmaceutical waste within the single waste conduit 102. The diluent conduit 202, the first reagent conduit 302, and the second reagent conduit 402 are arranged to introduce flow in a substantially perpendicular orientation relative to the flow direction through the waste conduit 102 to facilitate mixing of fluid within the waste conduit 102. In other embodiments, the arrangement of the diluent conduit 202, the first reagent conduit 302, and the second reagent conduit 402 with respect to the waste conduit 102 may be different.

As shown in FIG. 1, the drainage system 100 additionally includes a control system 500 that is configured to coordinate operations of the various system components, including the first fluid driver 118, the diluent pump 206, the diluent valve 208, the first reagent pump 306, the first reagent valve 304, the second reagent pump 406, and the second reagent valve 408. The control system 500 is configured to control the various system components to ensure the proper allocation of diluents and reagents to the pharmaceutical waste introduced through the inlet 104 of the waste conduit 102. More specifically, the control system 500 is configured to receive sensor data from the sensors and selectively control the valves and/or pumps to introduce the appropriate amount of diluents and reagents into the waste conduit 102 to neutralize the pharmaceutical waste on the fly, and to coordinate the release of reactants with the introduction of the pharmaceutical waste at the inlet 104.

In the embodiment of FIG. 1, the control system 500 includes a controller 501 (e.g., a pharmaceutical waste control circuit, etc.), inlet flow sensor 502, an intermediate flow sensor 504, and an outlet flow sensor 506. Each sensor is communicably coupled to the controller 501. In other embodiments, the control system 500 may include additional, fewer, and/or different sensors. For example, the control system 500 may include pH sensors or other fluid quality sensors to monitor the effectiveness of the treatment operation. The controller 501 may be programmable and may include a user interface to facilitate user interaction with the controller 501. The user interface may include a display (e.g., an LED screen, a touchscreen, etc.) to present system operating parameters to the user and/or to receive user input. The user interface may also include menu/programming buttons so that a user may navigate between different settings and parameters, and make any necessary adjustments. The user interface may include programmable firmware/software to facilitate monitoring of system operating parameters and interaction with the controller 501. Additionally, the controller 501 may also include data ports (e.g., input/output ports) to facilitate connections with components of the drainage system 100.

In one embodiment, the controller 501 may be accessed remotely from one or more Internet of Things (IoT) devices. For example, the controller 501 may include a transceiver 508 (e.g., an onboard IoT connection) configured to transmit data to and receive data from (e.g., system operation parameters, flow rates, fluid levels, reagent status, pump status, cycles run, etc.) a remote server (e.g., through a wireless network, etc.) or another IoT device. The remote server may form part of a cloud computing environment from which users can remotely access data regarding operation of the drainage system 100. For example, the remote server may populate data from the controller 501 into a software application that can be accessed by a user device (e.g., a laptop computer, a mobile phone, etc.) via the internet, or another long range or short range communications format. The user may send commands to the controller 501 through the remote server, and/or through a wireless gateway (e.g., via Bluetooth, Wi-Fi, or another wireless communications format). In addition to remote monitoring, the remote server may provide updates to the algorithms used to control operation of the drainage system 100. The remote server may also aggregate data from the controller 501 and change control parameters to improve the performance of the control system 500 based on the data.

In one embodiment, each of the sensors is a flow/volume detection sensor. The sensors may be configured to determine a fluid flow rate (e.g., mL/min, L/min, etc.) through the waste conduit 102 at different locations along the waste conduit 102. In one embodiment, each of the sensors includes a pair of sensors to improve the reliability of the flow detection and/or flow rate measurement. As shown in FIG. 1, the inlet flow sensor 502 is coupled to the waste conduit 102 proximate to the inlet 104 of the waste conduit 102, upstream of the first fluid driver 118. The inlet flow sensor 502 is configured to transmit inlet data indicative of an inlet fluid flow rate of pharmaceutical waste to the controller 501. The intermediate flow sensor 504 is coupled to the waste conduit 102 at a location downstream of the diluent dispensing system 200 (e.g., the diluent conduit 202). As such, the intermediate flow sensor 504 is configured to transmit intermediate data indicative of an intermediate fluid flow rate to the controller 501. The intermediate flow rate is the combined flow rate of the pharmaceutical waste and the diluent as it passes by the intermediate flow sensor 504. The outlet flow sensor 506 is coupled to the waste conduit 102 at a location downstream of the first reagent dispensing system 300 (e.g., first reagent conduit 302) and the second reagent dispensing system 400 (e.g., the second reagent conduit 402). The outlet flow sensor 506 is configured to transmit outlet data indicative of an outlet fluid flow rate through the waste conduit 102 to the controller 501 (e.g., a fluid flow rate leaving through the outlet 106 of the waste conduit 102). The outlet flow rate is the combined flow rate of the pharmaceutical waste, the diluent, and the first and second reagents.

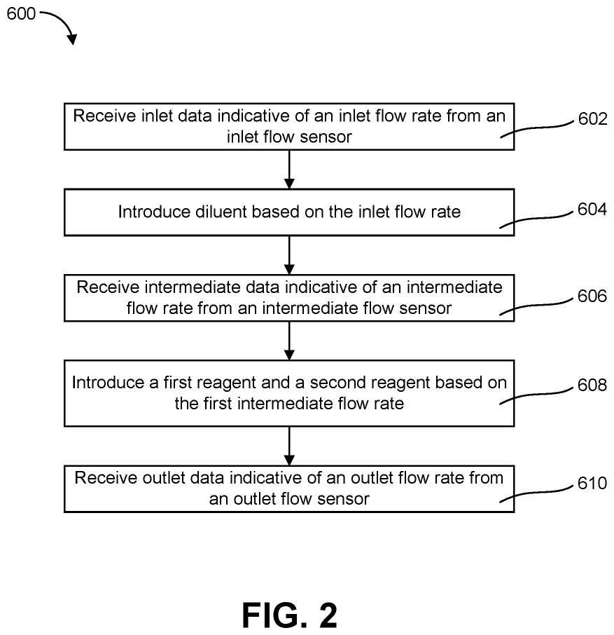

Referring to FIG. 2, a flow diagram of a method 600 of treating pharmaceutical waste on the fly is shown, according to an embodiment. The method 600 may be implemented using the controller 501 of FIG. 1, for example, through a software application installed on the controller 501. As such, reference will be made to the controller 501 when describing method 600. In another embodiment, the method 600 may include additional, fewer, and/or different operations. It will be appreciated that the use of a flow diagram and arrows is not meant to be limiting with respect to the order or flow of operations. For example, in one embodiment, two or more of the operations of method 600 may be performed simultaneously.

At operation 602, the controller 501 receives inlet data indicative of an inlet fluid flow rate at an inlet of a waste conduit (e.g., the waste conduit 102 of FIG. 1). Operation 602 may include receiving the inlet flow rate from an inlet flow sensor (e.g., inlet flow sensor 502) via a communications interface and/or data ports of the controller 501. The inlet flow rate data may be indicative of a flow rate of pharmaceutical waste received by the waste conduit. For example, the inlet flow rate data may be voltage data or other real-time readings from the inlet flow sensor, which may be converted by the controller 501 to values of flow rate (e.g., in mL/min) using an algorithm or based on an interpolation table stored in memory of the controller 501. Method 600 may also include activating, by the controller 501, a first fluid driver (e.g., first fluid driver 118) to move the pharmaceutical waste through the waste conduit. Among other benefits, using the first fluid driver increases the maximum flow rate of pharmaceutical waste that can be achieved using the drainage system and allows for more precise control over the flow rate of pharmaceutical waste entering the waste conduit 102. In other embodiments, the pharmaceutical waste travels through the waste conduit 102 by gravity.

At operation 604, the controller 501 introduces (e.g., dispenses, supplies, etc.) a diluent (e.g., water) based on the inlet flow rate. For example, operation 604 may include selectively operating a diluent dispensing system to dispense diluent into the waste conduit based on the inlet flow rate. Operation 604 may include determining a diluent flow rate and/or a calculated amount of diluent needed to dilute the pharmaceutical waste based on the inlet fluid flow rate; for example, by scaling the inlet flow rate by a diluent factor and activating a diluent pump and/or diluent valve achieve the diluent flow rate. Operation 604 may include transferring the diluent from a diluent cartridge, through a diluent conduit, and into the waste conduit. In another embodiment, operation 604 may include crawling through a lookup table that includes operating parameters for the diluent pump and/or valve as a function of the inlet flow rate. Operation 604 may further include mixing the diluent with the pharmaceutical waste within the waste conduit, due to the natural flow mixing that occurs within the waste conduit.

At operation 606, the controller 501 receives intermediate data indicative of an intermediate flow rate. Operation 606 may include receiving the intermediate flow rate from an intermediate flow sensor (e.g., intermediate flow sensor 504) via a communications interface and/or data ports of the controller 501. The intermediate flow rate may be indicative of a combined flow rate of pharmaceutical waste and diluent. The data may be used to check that an appropriate amount of diluent has been added to the pharmaceutical waste by the diluent dispensing system; for example, by subtracting the inlet flow rate from the intermediate flow rate, and comparing the result to the diluent flow rate from operation 604. In one embodiment, operation 606 includes iteratively varying operation of the diluent pump and/or diluent valve to achieve the desired diluent flow rate. Additionally, operation 604 may include shutting down the drainage system in the event that no diluent flow is detected by the intermediate flow sensor (e.g., by deactivating the first fluid driver). Operation 606 may also include converting and/or manipulating the data to a form that is suitable for use by the controller 501, similar to the example described in operation 602.

At operation 608, the controller 501 introduces (e.g., dispenses, supplies, etc.) a reagent into the waste conduit based on the intermediate fluid flow rate. For example, operation 608 may include selectively operating a reagent dispensing system to dispense reagent into the waste conduit based on the intermediate flow rate. In the embodiment of FIG. 2, operation 608 includes introducing two reagents into the waste conduit based on the intermediate flow rate, including a 30% reagent grade hydrogen peroxide and an aqueous iron. Operation 608 may include determining a flow rate of the first reagent and the second reagent and/or a calculated amount of the first reagent and the second reagent needed to neutralize the pharmaceutical waste based on the intermediate flow rate; for example, by scaling the intermediate flow rate by a reagent factor and activating a reagent pump and/or reagent valve to achieve the desired reagent flow rate. Operation 608 may include transferring the first reagent and second reagent from cartridges, through separate reagent conduits, and into the waste conduit. In another embodiment, operation 608 may include crawling through a lookup table that includes operating parameters for the reagent pumps and/or valves as a function of the intermediate flow rate. Operation 608 may further include mixing the first reagent and the second reagent with the pharmaceutical waste within the waste conduit, due to the natural flow mixing that occurs within the waste conduit.

At operation 610, the controller 501 receives outlet data indicative of an outlet flow rate. Operation 610 may include receiving the outlet flow rate from an outlet flow sensor (e.g., outlet flow sensor 506) via a communications interface and/or data ports of the controller 501. The outlet flow rate may be indicative of a combined flow rate of the pharmaceutical waste, diluent, and the first and second reagents. The data may be used to check that an appropriate amount of each reagent has been added to the pharmaceutical waste by the first reagent dispensing system and the second reagent dispensing system; for example, by subtracting the intermediate flow rate from the outlet flow rate, and comparing the result to the combined reagent flow rate (e.g., the combined flow rate of the first reagent and the second reagent) from operation 608. In one embodiment, operation 610 may include iteratively varying operation of the reagent pumps and/or reagent valves to achieve the desired reagent flow rates. Additionally, operation 610 may include confirming that the pharmaceutical waste has been processed/treated and is leaving the drainage system. Operation 610 may include shutting down the drainage system in the event that no reagent flow is detected by the outlet flow sensor (e.g., by deactivating the first fluid driver). Operation 610 may also include converting and/or manipulating the data to a form that is suitable for use by the controller 501, similar to the example described in operation 602. Method 600 additionally includes passing the treated pharmaceutical waste to an outlet of the drainage system (e.g., a plumbing drain connection or an effluent tank).

Any of the operations described herein can be performed by computer-readable (or computer-executable) instructions that are stored on a computer-readable medium such as memory of the controller. The computer-readable medium can be a computer memory, database, or other storage medium that is capable of storing such instructions. Upon execution of the computer-readable instructions by a computing device such as the controller or a computer in communication with the controller, the instructions can cause the computing device to perform the operations described herein. For example, the computer-readable medium of the controller may tabulate sensor data, maintain sensor data history in the memory, and enable reporting of all functions of each component of the drainage system. The computer readable medium may be connected to a central processing unit having wireless compatibility.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

For the purposes of this disclosure and unless otherwise specified, “a” or “an” means “one or more.” As used herein, the singular forms “a,” “an,” and “the” designate both the singular and the plural, unless expressly stated to designate the singular only. Likewise, singular forms of terms designate both the singular and plural, unless expressly stated to designate the singular only.

The term “about” in connection with numerical values and ranges means that the number comprehended is not limited to the exact number set forth herein, and is intended to refer to ranges substantially within the quoted range while not departing from the scope of the invention. As used herein, “about” will be understood by persons of ordinary skill in the art and will vary to some extent on the context in which it is used.

While some embodiments have been illustrated and described, it should be understood that changes and modifications can be made therein in accordance with ordinary skill in the art without departing from the invention in its broader aspects as defined in the following claims.

What is claimed is:

1. A system for treating pharmaceutical waste at a location at which the pharmaceutical waste is disposed, the system comprising:
a waste conduit having an inlet configured to receive the pharmaceutical waste;
a diluent conduit fluidly coupled to the waste conduit and configured to discharge water into the waste conduit;
a first reagent conduit fluidly coupled to the waste conduit and configured to dispense a first reagent into the waste conduit; and
a second reagent conduit fluidly coupled to the waste conduit and configured to discharge a second reagent into the waste conduit.

2. The system of claim 1, wherein the waste conduit further comprises an outlet disposed downstream from the second reagent conduit, and wherein the waste conduit is free of waste-receiving vessels between the inlet and the outlet.

3. The system of claim 1, wherein the system is configured such that the pharmaceutical waste flows continuously along an entire length of the waste conduit.

4. The system of claim 1, wherein both the first reagent conduit and the second reagent conduit are fluidly coupled to the waste conduit downstream from the diluent conduit.

5. The system of claim 1, further comprising a fluid driver fluidly coupled to the waste conduit and configured to move fluid along the waste conduit.

6. The system of claim 1, further comprising a flow detection sensor coupled to the waste conduit upstream of the diluent conduit.

7. The system of claim 1, wherein each of the diluent conduit, the first reagent conduit, and the second reagent conduit comprise a valve and a pump, wherein the valve is configured to selectively prevent flow from entering the waste conduit, and wherein the pump is configured to meter flow into the waste conduit at a predetermined rate.

8. The system of claim 1, wherein the first reagent conduit is fluidly coupled to a first reagent cartridge configured to dispense the first reagent and the second reagent conduit is fluidly coupled to a second reagent cartridge configured to dispense the second reagent.

9. The system of claim 1, wherein the first reagent is a hydrogen peroxide solution configured to be utilized in a chemical reaction to treat the pharmaceutical waste and wherein the second reagent is an aqueous iron solution configured to be utilized in the chemical reaction.

10. A control system, comprising:
an inlet flow sensor coupled to a waste conduit;
a diluent dispensing system fluidly coupled to the waste conduit, the diluent dispensing system disposed downstream of the inlet flow sensor;
a reagent dispensing system fluidly coupled to the waste conduit downstream, the reagent dispensing system disposed downstream of the diluent dispensing system; and
a pharmaceutical waste disposal circuit communicably coupled to the inlet flow sensor, the diluent dispensing system, and the reagent dispensing system, the pharmaceutical waste disposal circuit configured to:
receive inlet data indicative of an inlet fluid flow rate from the inlet flow sensor;
determine a diluent flow rate based on the inlet fluid flow rate;
selectively operate the diluent dispensing system to dispense diluent based on the diluent flow rate;
determine a reagent flow rate based on the inlet fluid flow rate and the diluent flow rate; and
selectively operate the reagent dispensing system to dispense reagent based on the reagent flow rate.

11. The control system of claim 10, further comprising a fluid driver communicably coupled to the pharmaceutical waste disposal circuit and configured to move fluid continuously along the waste conduit, wherein the pharmaceutical waste disposal circuit is further configured to selectively activate the fluid driver based on the inlet fluid flow rate.

12. The control system of claim 11, further comprising an outlet flow sensor downstream of the reagent dispensing system and communicably coupled to the pharmaceutical waste disposal circuit, wherein the pharmaceutical waste disposal circuit is configured to control the fluid driver based on outlet data from the outlet flow sensor.

13. The control system of claim 10, wherein the diluent dispensing system comprises a diluent valve configured to selectively fluidly couple a diluent supply with the waste conduit.

14. The control system of claim 10, further comprising an intermediate flow sensor downstream of the diluent dispensing system and communicably coupled to the pharmaceutical waste disposal circuit, wherein the reagent dispensing system comprises a reagent micropump and a reagent valve, and wherein the pharmaceutical waste disposal circuit is further configured to:
receive intermediate data indicative of an intermediate flow rate from the intermediate flow sensor; and
activate the reagent micropump to deliver the reagent to the reagent valve based on the intermediate flow rate; and
activate the reagent valve based on the intermediate flow rate to fluidly couple the reagent micropump with the waste conduit.

15. The control system of claim 14, wherein the reagent dispensing system is one of a plurality of reagent dispensing systems communicably coupled to the pharmaceutical waste disposal circuit, wherein a first reagent dispensing system is configured to dispense a hydrogen peroxide solution into the waste conduit, and a wherein a second reagent dispensing system is configured to dispense aqueous iron into the waste conduit.

16. A method, comprising:
receiving inlet data indicative of an inlet fluid flow rate into a waste conduit from an inlet flow sensor;
determining a diluent flow rate based on the inlet fluid flow rate;
dispensing, by a diluent dispensing system, a diluent into the waste conduit based on the diluent flow rate;
determining a reagent flow rate based on the inlet fluid flow rate and the diluent flow rate; and
dispensing, by a reagent dispensing system downstream from the diluent dispensing system, a reagent into the waste conduit based on the reagent flow rate.

17. The method of claim 16, further comprising moving a pharmaceutical waste along the waste conduit continuously via a fluid driver that is fluidly coupled to the waste conduit.

18. The method of claim 17, wherein dispensing the diluent comprises selectively fluidly coupling the waste conduit with a diluent supply via a diluent valve.

19. The method of claim 16, wherein dispensing the reagent comprises:
receiving intermediate data indicative of an intermediate flow rate from an intermediate flow sensor disposed downstream from the diluent dispensing system;
delivering the reagent, via a reagent micropump, to a reagent valve based on the intermediate flow rate; and
selectively fluidly coupling the reagent micropump to the waste conduit by selectively activating the reagent valve.

20. The method of claim 19, wherein the reagent is one of a plurality of reagents, and wherein the method further comprises determining a second reagent flow rate based on the inlet fluid flow rate and the diluent flow rate, and dispensing, via a second reagent dispensing system downstream from the diluent dispensing system, a second reagent into the waste conduit based on the second reagent flow rate.
